(19) United States
(12) Patent Application Publication
(10) Pub. No.: US 2011/0247763 A1
(43) Pub. Date: Oct. 13, 2011

(54) RESTRICTION MECHANISM FOR CURTAIN ASSEMBLY

(75) Inventors: WEN-HSING HU, Changhua County (TW); Sheng Ying Hsu, Changhua County (TW)

(73) Assignee: CHING FENG HOME FASHIONS CO., LTD., CHANGHUA COUNTY (TW)

(21) Appl. No.: 12/757,016

(22) Filed: Apr. 8, 2010

(51) Int. Cl. E06B 9/24

(52) U.S. Cl. 160/84.03

(57) ABSTRACT

A curtain assembly a top box and a first curtain and a second curtain are connected to the scrolling mechanism in the top box. The second end of the first curtain is connected to the second end of the second curtain by multiple securing units which are fixed to a transverse bar on the second curtain. Multiple restriction members each include a clamping part and an elongate plate which extends perpendicularly from the clamping part. The second curtain includes multiple transverse sections separated by section rods which extend through passages defined transversely in the second curtain. Each passage communicates with two notches which are located corresponding to two sides of the first curtain. The clamping parts of the restriction members are inserted through the notches and clamp the section rods, and the elongate plates are located outside of the first curtain.

### FIELD OF THE INVENTION

The present invention relates to a curtain assembly, and more particularly, to a restriction mechanism for positioning the operation curtain on the Roman shade.

### BACKGROUND OF THE INVENTION

A conventional Roman shade that includes an operation curtain on the inside of the Roman shade, and the operation curtain is connected to the Roman shade so that when scrolling the operation curtain, the Roman shade is scrolled upward or released downward. The Roman shade is connected to the top box and multiple restriction mechanisms are connected to the inside of the Roman shade. Multiple fixing units are connected beneath the lowest restriction mechanism. The operation curtain has one end connected to the top box and the other end of the operation curtain extends through the restriction mechanisms and is clamped by the fixing units.

However, the fixing units and the restriction mechanisms each involve many parts which have complicated shapes so that it takes a long time to assemble the Roman shade and the operation curtain. Besides, the operation curtain has to include rods with C-shaped opening so as to be inserted transversely through the passages of the Roman shade to form multiple sections. The range of change is so large that the existed Roman shades cannot be cooperated with the operation curtain.

The present invention intends to provide a restriction mechanism that easily connects the operation curtain to the Roman shade and position the operation curtain relative to the Roman shade.

### SUMMARY OF THE INVENTION

The present invention relates to a curtain assembly and comprises a top box in which a scrolling mechanism is received. A first curtain has a first end connected to the scrolling mechanism and a bottom rod is connected to a second end of the first curtain. A second curtain has a first end connected to the scrolling mechanism and the second end of the first curtain is connected to a second end of the second curtain by multiple securing units. The securing units are fixed to a first transverse bar on the second curtain and the bottom rod of the first curtain is clamped by the securing units. Multiple restriction units are connected to the second curtain and each have a restriction member. The restriction member includes a clamping part and an elongate plate which extends from the clamping part. The second curtain includes multiple transverse sections separated by section rods which extend through passages defined transversely in the second curtain. Each passage communicates with at least two notches which are located corresponding to two sides of the first curtain. The clamping parts of the restriction members are inserted through the at least two notches and clamp the section rods. The elongate plates are located on outside of the second curtain.

The securing units and the restriction units of the present invention are easily manufactured and include simple structure. The securing units are fixed to the second curtain and clamp the first curtain. The use of the restriction units requires notches in the second curtain and the clamping parts of the restriction units can restrict the first curtain and clamp the section rods in the second curtain.

The restriction units can be used to the existed Roman shades (second curtains) and the section rods of the existed Roman shades do not need to be changed.

The restriction units are located on two sides of the operation curtain (first curtain) and clamp the section rods in the Roman shade (second curtain) so that the operation curtain is well positioned while operation.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the curtain assembly of the present invention;

FIG. 2 shows a part of the curtain assembly of the present invention;

FIG. 3 shows the restriction unit to be connected with the section rod in the Roman shade of the curtain assembly of the present invention;

FIG. 4 shows that the Roman shade and the operation curtain of the curtain assembly of the present invention are collected;

FIG. 5 is a side cross sectional view of the curtain assembly of the present invention;

FIG. 6 is a partial cross sectional view to show the relative position between the restriction unit, the operation curtain and the Roman shade of the curtain assembly of the present invention;

FIG. 7 shows the securing unit connecting the operation curtain and the Roman shade of the curtain assembly of the present invention;

FIG. 8 is an exploded view to show the securing unit of the curtain assembly of the present invention, and

FIG. 9 is a cross sectional view of the securing unit of the present invention.

### DETAILED DESCRIPTION OF THE PREFERRED EMBODIMENT

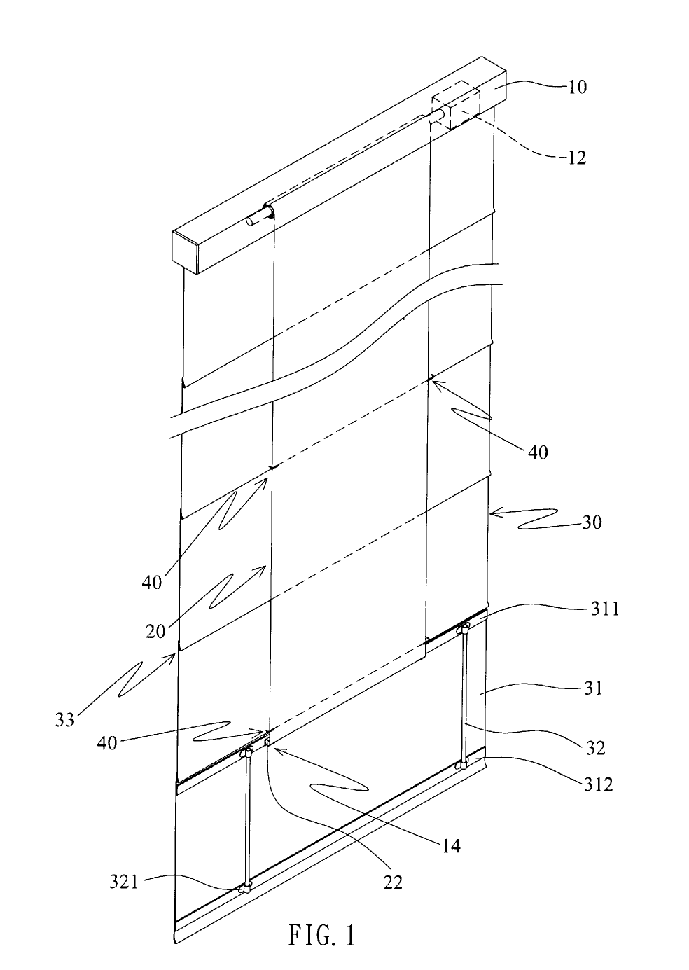

Referring to FIG. 1, the curtain assembly of the present invention comprises a top box 10 in which a scrolling mechanism 12 is received, a first curtain 20 such as an operation curtain, and a second curtain 30 such as a Roman shade. The first curtain has a first end connected to the scrolling mechanism 12 and a bottom rod 22 is connected to a second end of the first curtain 20.

The second curtain 30 has a first end connected to the scrolling mechanism 12 and the first curtain 20 is located on a surface of the second curtain 30. The second curtain 30 includes multiple transverse sections 33 separated by section rods 34 which extend through passages 331 defined transversely in the second curtain 30. Each passage 331 communicates with two notches 35 which are located corresponding to two sides of the first curtain 20. A bottom section 31 is connected to the second end of the second curtain 30 and includes a first transverse bar 311 and a second transverse bar 312. Two upright rids 32 are connected to the bottom section 31 in upright direction. Two ends of each of the first and second transverse bars 311 are secured by two frames 321.

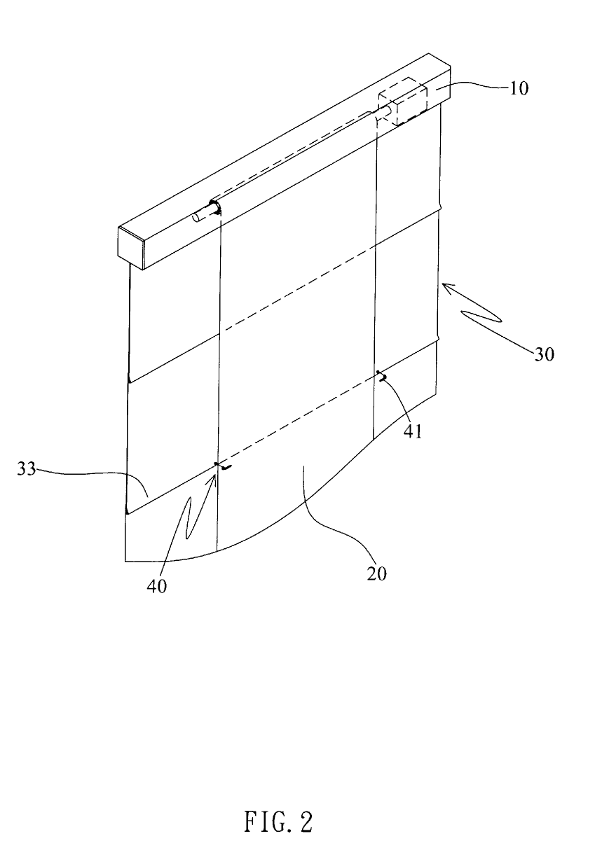

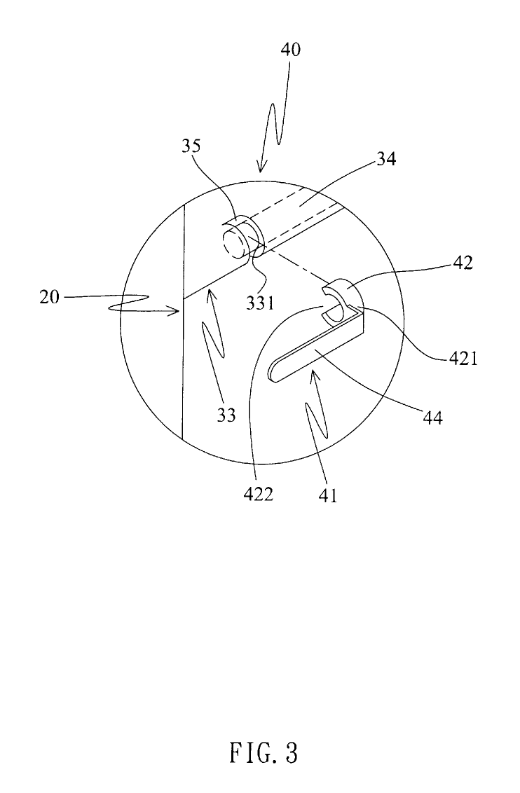

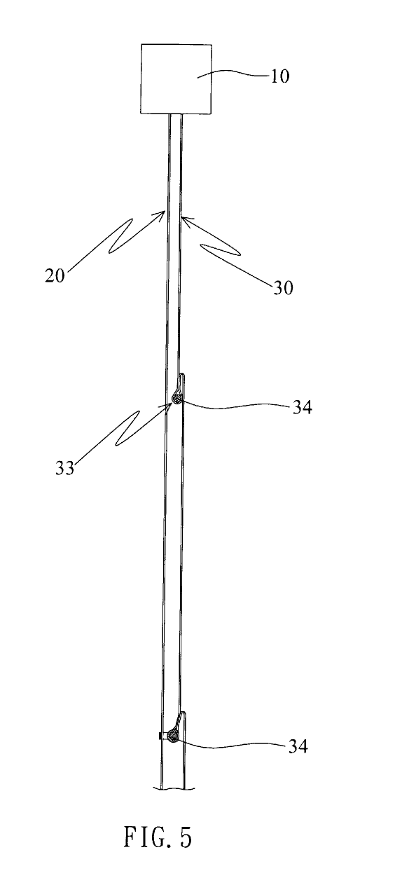

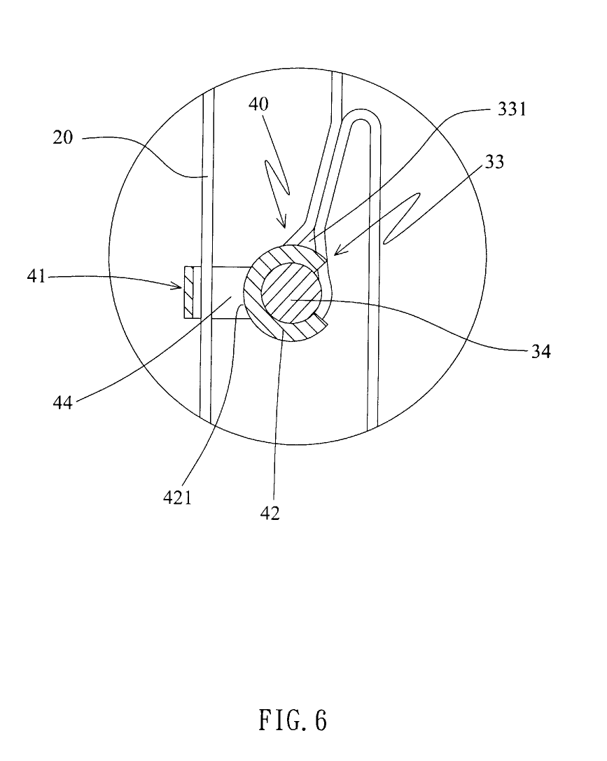

As shown in FIGS. 2, 3, 5 and 6, multiple restriction units 40 are used to restrict the first curtain 20 and each restriction unit 40 includes a restriction member 41 which includes a clamping part 42 and an elongate plate 44. Each restriction member 41 includes a C-shaped clamping part 42 and a distal end 421 of the elongate plate 44 is connected to and extends perpendicularly from a back of the C-shaped clamping part 42. The distal end 421 and the C-shaped clamping part 42 extend beyond each of the two sides of the first curtain 20 and the C-shaped clamping part 42 extend perpendicularly from the distal end 421 of the elongate plate 44, such that the elongate plate 44 is parallel to the first curtain 20 and the C-shaped clamping part 42 is perpendicular to the first curtain 20. In other words, the two sides of the first curtain 20 are restricted by the C-shaped clamping parts 42 so that the first curtain 20 does not swing relative to the top box 10. The elongate plates 44 are located such that the first curtain 20 does not flip away from the second curtain 30.

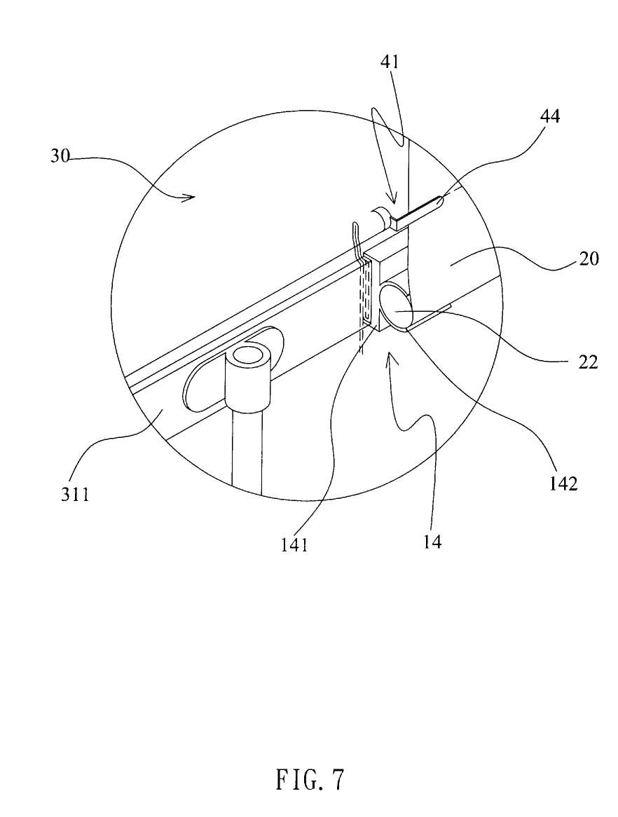

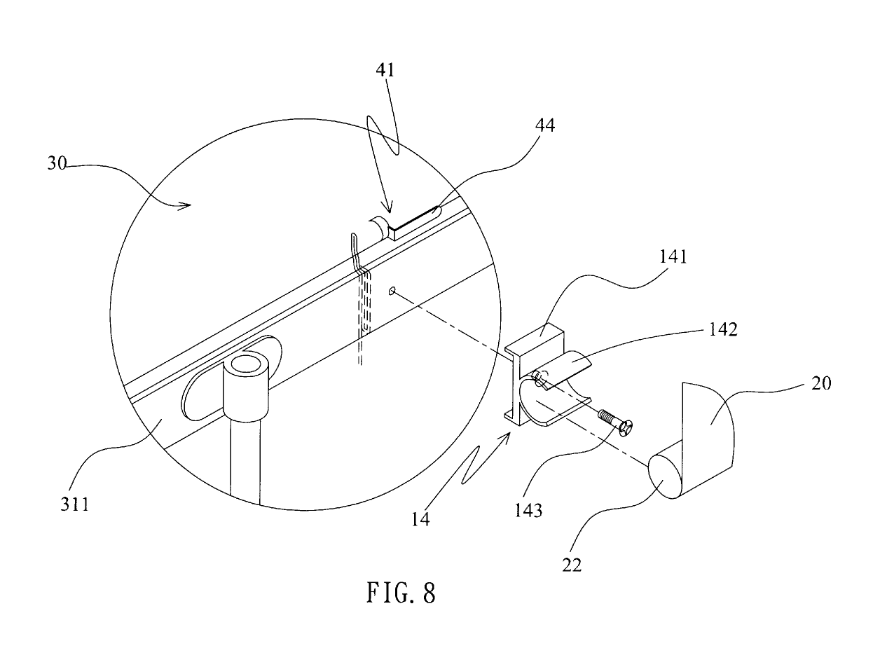

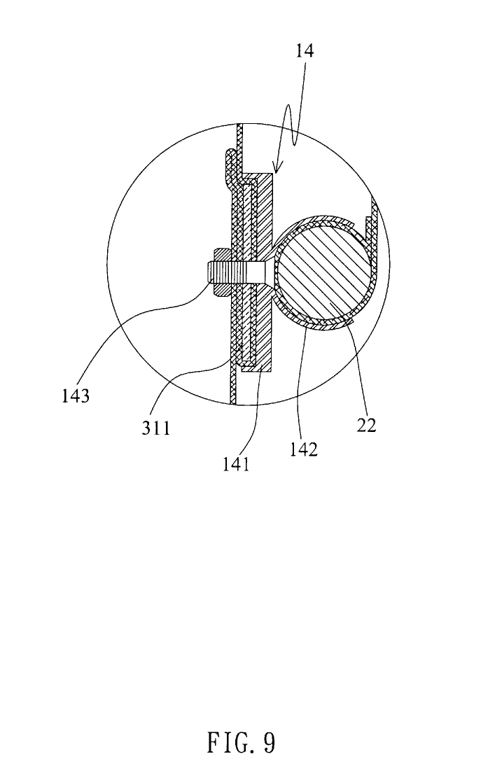

Referring to FIGS. 7 to 9, the second end of the first curtain 20 is connected to the second end of the second curtain 30 by multiple securing units 14. The securing units 14 are fixed to the first transverse bar 311 on the second curtain 30 and the bottom rod 22 of the first curtain 20 is clamped by the securing units 14. In this embodiment, each securing unit 14 includes a U-shaped fixing portion 141 and a C-shaped clamping portion 142. The fixing portion 141 is fixed to the first transverse bar 311 of the second curtain 30 by bolts 143 and the bottom rod 22 is clamped by the clamping portion 142.

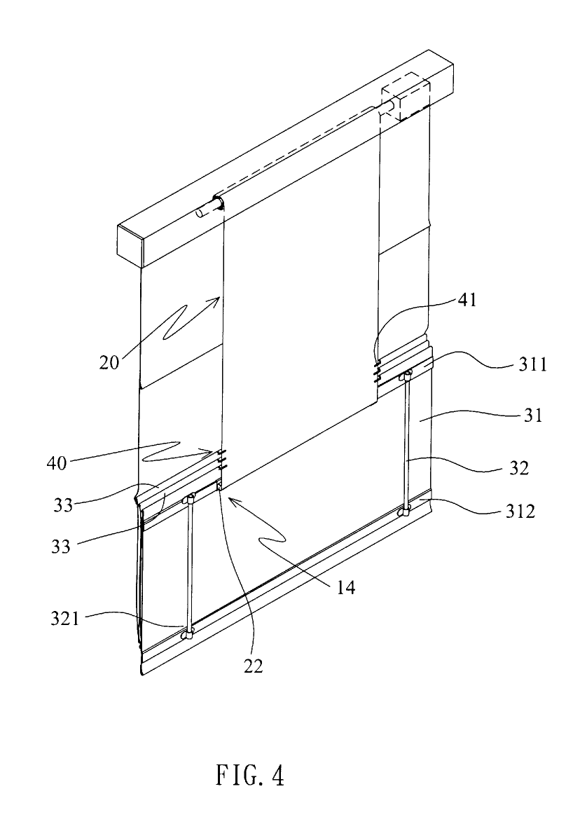

By this arrangement, the first curtain 20 is well positioned by the restriction members 41 and does not shake or shift when in operation. As shown in FIG. 4, when lifting the second end of the first curtain 10, the second end of the second curtain 30 is lifted because the restriction units 40 connect the first and second curtains 20, 30.

Because the securing units 14, the first curtain 20 always in good shape and does not mess with the second curtain 30. The second curtain 30 is lifted and folded section 33 by section 33.

While we have shown and described the embodiment in accordance with the present invention, it should be clear to those skilled in the art that further embodiments may be made without departing from the scope of the present invention.

What is claimed is:

1. A curtain assembly comprising:
a top box in which a scrolling mechanism is received;
a first curtain having a first end connected to the scrolling mechanism, a bottom rod connected to a second end of the first curtain;
a second curtain having a first end connected to the scrolling mechanism, the second end of the first curtain connected to a second end of the second curtain by multiple securing units, the securing units fixed to a first transverse bar on the second curtain and the bottom rod of the first curtain being clamped by the securing units, and
multiple restriction units each having a restriction member, the restriction member including a clamping part and an elongate plate which extends from the clamping part, the second curtain including multiple transverse sections separated by section rods which extend through passages defined transversely in the second curtain, each passage communicating with at least two notches which are located corresponding to two sides of the first curtain, the clamping parts of the restriction members being inserted through the at least two notches and clamping the section rods, the elongate plates located on outside of the second curtain.

2. The curtain assembly as claimed in claim 1, wherein each securing unit includes a U-shaped fixing portion and a C-shaped clamping portion, the fixing portion is fixed to the first transverse bar of the second curtain and the bottom rod is clamped by the clamping portion.

3. The curtain assembly as claimed in claim 1, wherein each restriction member includes a C-shaped clamping part and a distal end of the elongate plate is connected to a back of the C-shaped clamping part.

4. The curtain assembly as claimed in claim 3, wherein the distal end and the C-shaped clamping part extend beyond each of the two sides of the first curtain and the C-shaped clamping part extend perpendicularly from the distal end of the elongate plate, such that the elongate plate is parallel to the first curtain and the C-shaped clamping part is perpendicular to the first curtain.
